(19) United States
(12) Patent Application Publication
(10) Pub. No.: US 2008/0259942 A1
(43) Pub. Date: Oct. 23, 2008

(54) Arrangements For Providing Peer-To-Peer Communications In A Public Land Mobile Network

(76) Inventors: Robert Skog, Hasselby (SE); Ulf Olsson, Sollentuna (SE)

Correspondence Address: ERICSSON INC., 6300 LEGACY DRIVE, M/S EVR 1-C-11, PLANO, TX, 75024, US

(21) Appl. No.: 11/816,464

(22) PCT Filed: Oct. 21, 2005
(86) PCT No.: PCT/SE05/01575

§ 371 Date: Aug. 16, 2007

(30) Foreign Application Priority Data
Feb. 18, 2005 (SE) 0500384-3

(51) Int. Cl. H04L 12/28

(52) U.S. Cl. 370/401

(57) ABSTRACT

A node (200) for routing Peer-to-Peer, P2P, communication between subscribers in a public land mobile network, PLMN, adapted to be located as a gateway between the packet switched domain of the PLMN and an external Packet Data Network, PDN, comprising a routing functionality for routing messages between the packet switched domain of the PLMN and the external PDN, connectable to at least a second node, the node (200) wherein it further comprises a terminating functionality (202) for terminating a protocol carrying a request from a sending subscriber for an IP address given a MSISDN identity of a receiving subscriber, and a database (201) comprising the mapping between the IP address and the MSISDN identity of the receiving subscriber.

### FIELD OF THE INVENTION

The present invention relates to arrangements in a mobile communication network. In particular, the present invention relates to arrangements for providing peer-to-peer communication in a Public Land Mobile Network (PLMN).

### BACKGROUND OF THE INVENTION

FIG. 1 shows an example of a PLMN wherein the present invention may be implemented. The PLMN is in this example a UMTS network. It should however be noted that the present invention is not limited to UMTS. The PLMN 1 comprises a Gateway GPRS Support Node (GGSN) connected to a Home Local Register (HLR), to Serving GPRS Support Nodes (SGSN) and to a PSTN and a Packet Data Network (PDN). The GGSN is used for terminating PLMN protocols such as the GTP protocol and routing the IP-packets further. The HLR is used for authentication and the SGSN is e.g. responsible for authentication and authorization of basic GPRS connectivity and for mobility across Radio Access Network (RAN) areas. The PDN is typically an IP network comprising e.g. the Internet, enterprise network, infrastructure of service providers. The SGSN is further connected to the HLR and a RAN. The RAN in a UMTS network comprises at least one Radio Network Controller adapted to control several Node Bs. The Node Bs are connected to mobile terminals (also denoted User Equipment, UE) over the radio interface.

A peer-to-peer (P2P) computer network is a network that does not rely on dedicated servers for communication but instead mostly uses direct connections between clients (peers). A pure peer-to-peer network does not have the notion of clients or servers, but only equal peer nodes that simultaneously function as both “clients” and “servers” to the other nodes in the network.

This model of network arrangement differs from the client-server model where communication is usually relayed by the server. A typical example for a non peer-to-peer communication is email, where the email is transmitted to the server for delivery, transmitted to the destination between servers, and is fetched later by the receiving client. A direct transmission from a client to another client is often impossible. In a peer-to-peer network, any node is able to initiate or complete any supported transaction with any other node. Peer nodes may differ in local configuration, processing speed, network bandwidth, and storage quantity. IBM's Advanced Peer-to-Peer Networking (APPN) is an example of a product that supports the peer-to-peer communication model.

In recent usage, P2P has come to describe applications in which users can use the Internet to exchange files with each other directly or through a mediating server. On the Internet, P2P is a type of transient Internet network that allows a group of computer users with the same networking program to connect with each other and directly access files from one another's hard drives. Napster and Gnutella are examples of this kind of peer-to-peer software.

Corporations are looking at the advantages of using P2P as a way for employees to share files without the expense involved in maintaining a centralized server and as a way for businesses to exchange information with each other directly.

The section below gives a description how the Internet P2P works. The user must first download and execute a peer-to-peer networking program. Gnutellanet is currently one of the most popular of these decentralized P2P programs because it allows users to exchange all types of files. After launching the program, the user enters the IP address of another computer belonging to the network. Typically, the Web page where the user got the download lists several IP addresses as suggestions of places to begin. Once the computer finds another network member on-line, it will connect to that user's connection who has received their IP address from another user's connection and so on. Users can choose how many member connections to seek at one time and determine which files they wish to share or password protect.

Below is a brief description of different types of P2P networks.

### Centralized P2P Network

The first example is a centralized P2P network. A central server maintains directories of information for each attached node, i.e. each terminal. Each time a client logs on or off the P2P network, the directory is updated. Napster is one example of such a network.

### Decentralized P2P Network

Decentralized P2P network is a second example wherein each client communicates and share data without any direct central server. A look-up request is sent to one node (client). That node propagates the request to its connected clients. Gnutella is an example of a decentralized network. Because of the complicated nature of distributed searching, the Gnutella model is much more complex than the Napster model. Since each node propagates a search that it receives from all the other connected nodes, the Gnutella network would easily be congested with search traffic, leaving no bandwidth for other traffic.

### Controlled Decentralized P2P Network

The third model is the controlled decentralized P2P network. Unlike the Gnutella model, which treats each node equally, the controlled decentralized model introduces the concept of super nodes. A super node connects to more nodes than a regular node, which results in more search propagation through that super node. The nodes keep only a small number of connections open and each of those connections are to a super node. Skype and KaZaA are examples of this kind of P2P network.

Problems with P2P in a PLMN

In a cellular network, packet communication between mobiles, (User Equipment, UE) could be used for many different purposes: media transfer, voice communication, presence information sharing etc. This means that a UE A needs to find the address of UE B in some way. This section will list the existing and/or planned ways of doing this, and the related problems.

### IPv4 Address

GPRS allows static IP address allocation, wherein the IP address of UE B could be known to UE A á priori. However, this is not in practical use for at least the following reasons:

Address scarcity: Operators do not have enough routable IPv4 addresses to hand out.

Security: End user addresses are typically not exposed outside of the PLMN, in order to protect the end user from attacks.

### IPv6 Address

Use of the address space of IPv6 solves the scarcity problem, but the security issue remains.

### IMS Address (SIP URI)

By using Uniform Resource Identifiers (URI), users can be reached using names like sip:ernie.floyd@bayonne.com. This is likely the desirable long-term solution from the telecom industry point of view, as it provides a reliable and protective infrastructure that allows bearer optimization and the ability to charge for QoS.

Basically, the IP Multimedia Subsystem (IMS), e.g. connected to the GGSN, relies on a Session Initiation Protocol (SIP) Location Register that stores information about where the user can be found i.e., where SIP signals should be sent. For scalability reasons, it also contains a mechanism where signalling load can be shared over available resources by way of allocating users to responsible nodes such as the Serving Call/Session Control Function (S-CSCF), coupled with a routing mechanism such as the Interrogating Call/Session Control Function (I-CSCF).

A problem is however that the IMS is not yet deployed globally and it is therefore desirable to find a simpler way to find the target mobile terminal.

### E.164 MSISDN Address

In a PLMN network the E.164 MSISDN identity is used by end-users as a way to identity the other part. A P2P network in PLMN could use the same identity, but the binding MSISDN-IP is currently known to a few nodes such as the WAP Gateway.

### Performance in Wireless Networks

Due to the limitation of radio resources in wireless networks, there is a need to avoid polling from clients (mobile terminals). This means that a completely terminal-based P2P solution will most likely have negative effects on radio efficiency.

### Trust

In a P2P network, it is important to trust the received information, i.e., the receiver must trust the source, i.e. the node or super node that delivered the information. This is probably not a major issue if music is illegally downloaded, but if a P2P distributed database for communication is used, it is important to know that the used name is not being hijacked or misused in other ways. Thus, a solution is needed that can leverage existing networks of trust, for instance PLMNs and the GRX interconnect network that is further explained below.

EP 1385323 A1 shows a system for peer-to-peer exchange of information. This system does not require a common exchange server in the data network. A disadvantage with this system is that a sending subscriber A who wants to transmit a message to a subscriber B is required to first initialise a signalling communication with the subscriber B in order to obtain the IP address of subscriber B. This results in an increased signalling in the network and in particular over the radio interface.

The P2P system of Skype is considered to be the closest prior art and discloses the features of the preamble of claim 1. Skype available from www.skype.com is a controlled decentralized P2P network as described above. A disadvantage with Skype is however that keep alive messages over the radio interface is required which require resources.

Thus an object of the present invention is to provide an arrangement that achieves P2P communication in a PLMN that requires a reduced signalling.

### SUMMARY OF THE INVENTION

The objective problem is solved by the characterizing part of claim 1.

Thanks to the node according to the present invention, comprising a terminating functionality (202) for terminating a protocol carrying a request from a sending subscriber for an IP address given a MSISDN identity of a receiving subscriber, and

a database (201) comprising the mapping between the IP address and the MSISDN identity of the receiving subscriber, P2P communication in a PLMN is achieved.

Preferred embodiments are defined by the dependent claims.

An advantage with the present invention is that it allows for creation of innovative, terminal-based services that can grow organically without relying on pre-planned network resource growth. At the same time, by making PLMN resources (that must be scaled with traffic anyway) core elements in the solution, operators can still retain some level of control and visibility over the traffic in their network.

A further advantage with the present invention is that this can be used to open firewalls towards a receiving B-subscriber, as the sending A-subscriber side is trusted and acting on behalf of an authenticated (i.e., well-known) user. The mobile terminal of the B-subscriber does not need to send periodical keep alive messages. The same look-up request can also be used to make receiving parts radio bearer ready to receive incoming packets.

An advantage with the present invention is that the identity MSISDN is used. This is an advantage from a security point of view since the MSISDN is connected to a subscription and since the MSISDN is used as the primary identity in the PLMN. It should also be noted that MSISDN is a permanent identity in contrast to the IP address. The choice to use MSISDN as the identity is natural in most contexts where the IP flow is targeted to another mobile terminal, as the subscriber to be reached, i.e. the B subscriber may be identified in the phone number field of the address book of the A subscriber.

Other objects, advantages and novel features of the invention will become apparent from the following detailed description of the invention when considered in conjunction with the accompanying drawings and claims.

### BRIEF DESCRIPTION OF THE DRAWINGS

FIG. 1 shows an example of a PLMNs wherein the present invention may be implemented.

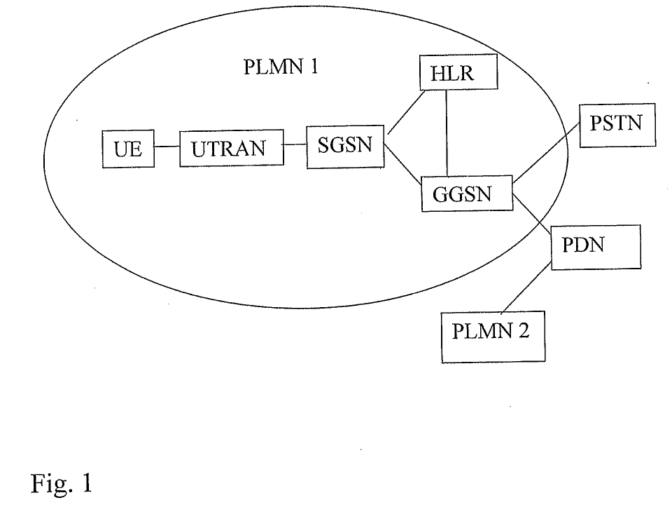

FIG. 2 shows a registration scenario in a P2P network super node according to the present invention.

FIG. 3 shows P2P network with a super node comprising GGSN according to the present invention.

FIG. 4 discloses a sequence of events in a P2P PLMN network according to an embodiment of the present invention.

FIG. 5 shows an address look-up via GGSN/Proxy trusted network and direct communication via the interface between the GGSN and a PDN according to an embodiment of the present invention.

### DESCRIPTION OF THE INVENTION

The present invention relates to arrangements for providing P2P communication in a PLMN. A Controlled Decentralized P2P network is selected for the invention in accordance with the description above. Such a controlled decentralized P2P network requires the introduction of a node acting as a super node into the PLMN. The node, also denoted super node, is located as a gateway between the packet switched domain of the PLMN and an external PDN such as the Internet and arranged to terminate PLMN protocols. Moreover, the super node comprises a routing functionality, which implies that incoming messages of the super node can be routed further towards its final destination. The functionalities of the super node according to the present invention are:
a terminating functionality for terminating a protocol carrying a request from a sending subscriber for an IP address given a MSISDN identity of a receiving subscriber, and
a database comprising the mapping between the IP addresses and the MSISDN identities.

According to an embodiment of the present invention, the super node comprises at least a GGSN and a data base. The super node comprises also a proxy according to a further embodiment. The routing functionality is preferably located in the GGSN.

The functionality for terminating the protocol, e.g. a http-based protocol, for carrying the IP look up requests may be located in the proxy or in the GGSN.

The database comprises IP addresses and MSISDN identities and a mapping between the IP address and MSISDN identity for the concerned UEs. The database is denoted session database in this specification. In accordance with an embodiment of the present invention, the database also comprises the identity of the network of the subscribers. In accordance with a further embodiment of the present invention, the database also comprises the address to the GGSN to which the subscribers belongs. The address to the GGSN of the receiving subscriber must hence be known if the database is shared by several GGSNs.

According to embodiments of the present invention, additional super node functionalities are:
a functionality for opening a firewall, and
a functionality for mapping private IP addresses to public IP addresses,

The functionality for opening a firewall comprises port opening means. The port opening means is arranged to open ports in the firewall so packets may pass to the IP address of the receiving subscriber inside the firewall.

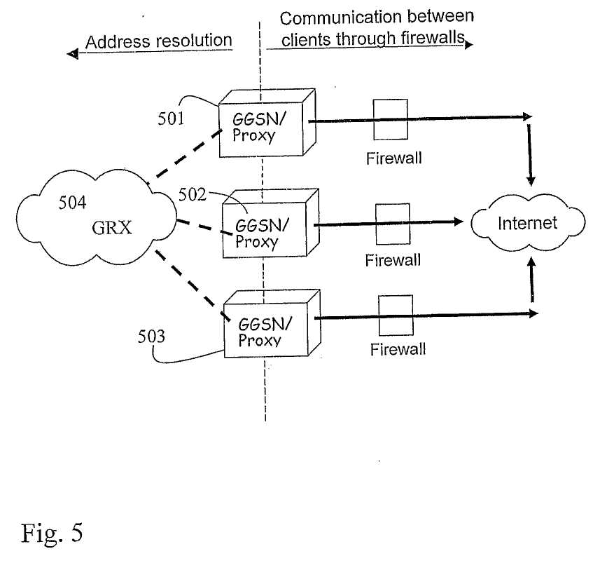

If the IP address of the receiving subscriber is a private address, i.e. not a public routable IP address, the super node may comprise the functionality for mapping private IP addresses to public IP addresses. This functionality is according to one of the embodiments implemented in the proxy. The proxy uses preferably Network Address Translation (NAT) services for performing the mapping. Network address translation (NAT), also known as network masquerading or IP-masquerading is a technique in which the source and/or destination addresses of IP packets are changed as they pass through a router or firewall. It is most commonly used to enable multiple hosts on a private network to access the Internet using a single public IP address. This functionality is further described in conjunction with FIG. 5.

According to a further embodiment of the present invention, an additional super node functionality is:
a functionality for initiating a radio connection to the receiving subscriber.

As described above, all the super node functionalities are implemented in a GGSN and/or in a dedicated proxy typically providing NAT services. It should however be noted that the super node functionalities also may be implemented in other nodes, separate or in any suitable combination.

The super nodes are preferably arranged hierarchically and are connected to a GRX network. The GRX network is a network that interconnects GPRS networks of different operators in a secure, protected and controlled way. It is hence impossible to reach the protected GPRS networks from the Internet. [0]

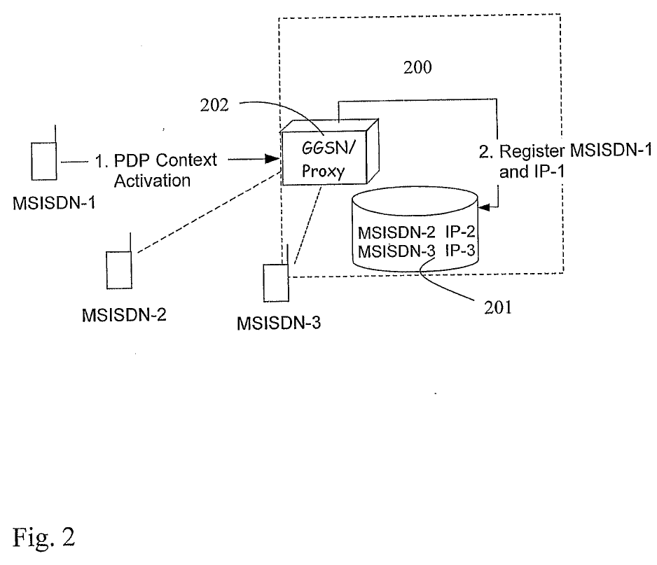

FIG. 2 shows a PDP context activation scenario in a mobile telecommunication network. When the subscriber, in this case MSISDN-1, logs on to the GPRS network, i.e. at the PDP Context Activation, the subscriber is given an IP-address while the subscriber received the MSISDN identity already when the subscription was created. The MSISDN is basically identical to the phone number and is connected to one SIM card. [0]

The mapping between the MSISDN and the IP address is stored in the session database 201 according to the present invention. The session database 201 may be stored in a separate GGSN, in a separate proxy 202, in a combined GGSN/proxy 202, in a HLR or in a separate node of the super node 200. Thus, the super node 200 comprises according to one embodiment the GGSN and the database. The super node according to another embodiment comprises the GGSN, the proxy and the database. It should be noted that the GGSN and the proxy either is a combined GGSN/proxy or located in separate units. The session database may also be located in the HLR if static IP addresses are used.

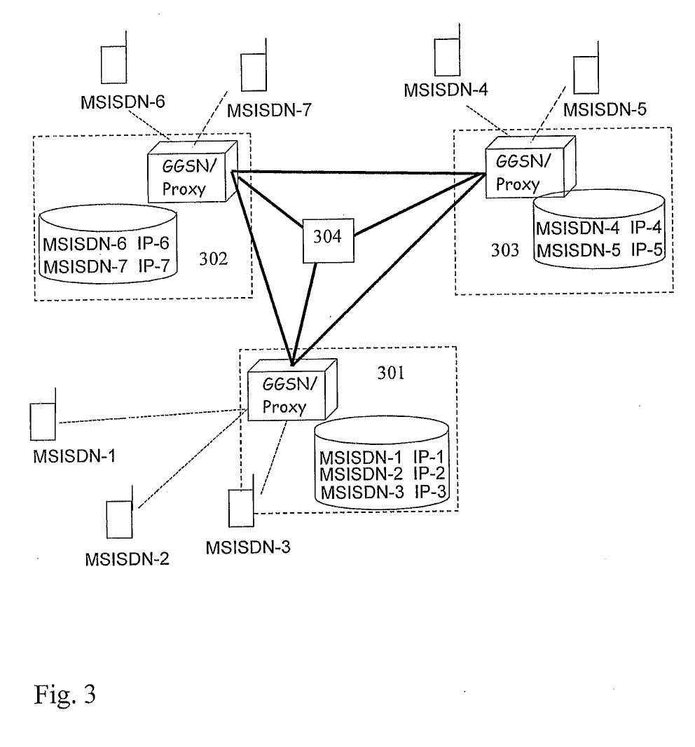

Below is an example of a P2P communication in an inter PLMN scenario as shown in FIG. 3. According to one embodiment, the super nodes in border networks 301, 302, 303 are not reached directly, but through super nodes located at a higher level in a GRX network such as the GRX node denoted 304 in FIG. 3. In order to avoid replicating super node queries to all connected networks, the GRX node is arranged to parse the MSISDN and to use a Flexible Number Register (FNR) to determine the mobile country code (mcc)/mobile network code (mnc) of the target network. Further optimization is achieved inside the network, if the operator applies a GGSN allocation policy that partitions the user space on MSISDN number ranges.

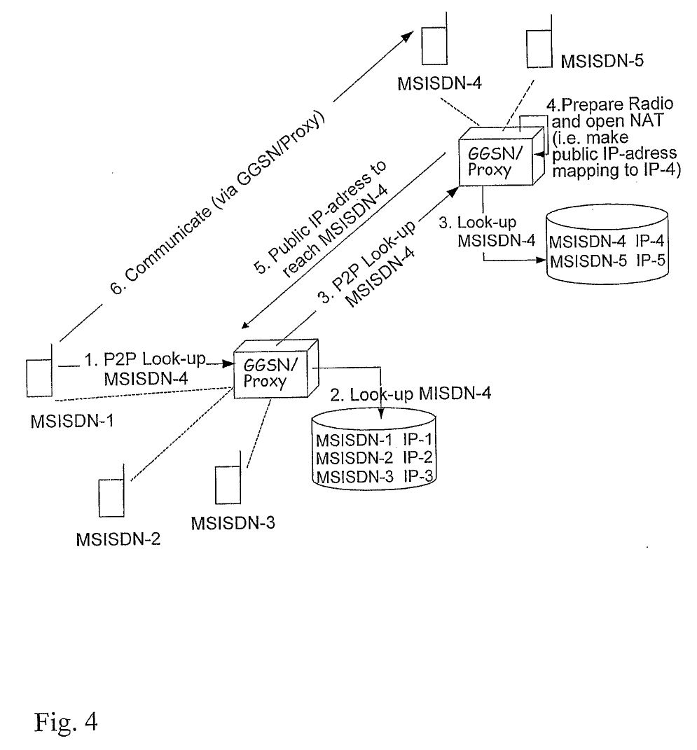

FIG. 4 shows a sequence of events for setting up a P2P communication according to the invention. FIG. 4 shows an embodiment of the present invention where the super node comprises a combined GGSN/proxy and a session data base. A subscriber with MSISDN-1 would like to send a picture to a subscriber with MSISDN-4. MSISDN-1 establishes a P2P connection with MSISDN-4 and MSISDN-1 starts then a P2P picture sending application.

1. MSISDN-1 sends a request to find the IP-address of MSISDN-4. MSISDN-4 is used as the identity and the request is sent to a predefined super node comprising the combined GGSN/Proxy.

2. The predefined super node checks the local register in its session database. In this example, is no MSISDN-4 stored.

3. The request is then sent to further super nodes in accordance in a predefined order. Only one further super node is shown in this example. The further super node finds the MSISDN-4 in its local register of the session database.

4. A signal is sent by a radio preparing functionality in the further super node to the radio access network which allows the radio access network to prepare for incoming packets. I.e. a radio channel is allocated to the mobile terminal having the identity MSISDN-4. Port opening means are provided for opening at least one port in the NAT functionality of the further super node (based on the IP address of MSISDN-4 and port number of the NAT) so the packets can reach MSISDN-4. The port opening means are triggered by the request for the IP address of MSISDN-4 from MSISDN-1. The MSISDN-4 is thus given a public routable IP-address and a port number by the NAT and the NAT maps the public routable IP-address and the port number to the private IP address of the MSISDN-4.

5. The public routable IP-address to MSISDN-4 is given back as a response to the MSISDN-1.

6. MSISDN-1 starts sending IP-packets for delivering of the picture to MSISDN-4.

FIG. 5 shows the super nodes 501, 502, 503 respectively comprising a combined GGSN/proxy having a session database. The left side of the firewalls is a trusted environment. The GRX network 504 in combination with one of the combined GGSN/proxy is used to find the IP address of a receiving subscriber. When the IP address of the receiving subscriber is found, the GGSN/proxy opens the firewall for packets from the sending subscriber. The NAT functionality is also used to open the firewall if the found IP address is a private IP address and therefore a mapping between the private IP address and the public IP address is required.

The concept of the present invention is based of abandoning the notion that information regarding how a mobile terminal can be reached in a mobile network must be built in a control hierarchy, i.e. that a central node is handling the requests. It should be noted that the present invention is not limited to the use of the GRX network, the GRX network is thus no required hierarchical network level but only a performance enhancing feature.

In the drawings and specification, there have been disclosed typical preferred embodiments of the invention and, although specific terms are employed, they are used in a generic and descriptive sense only and not for purposes of limitation, the scope of the invention being set forth in the following claims.

1. A node for routing Peer-to-Peer (P2P), communication between subscribers in a public land mobile network (PLMN) adapted to be located as a gateway between the packet switched domain of the PLMN and an external Packet Data Network (PDN), comprising:
a routing functionality for routing messages between the packet switched domain of the PLMN and the external PDN, connectable to at least a second node,
a terminating functionality for terminating a protocol carrying a request from a sending subscriber for an IP address given a MSISDN identity of a receiving subscriber, and
a database comprising the mapping between the IP address and the MSISDN identity of the receiving subscriber.

2. The node according to claim 1, wherein the routing functionality is located in a Gateway GPRS Support Node (GGSN).

3. The node according to claim 1, wherein the terminating functionality is located in a Gateway GPRS Support Node, GGSN.

4. The node according to claim 1, wherein the terminating functionality is located in a proxy.

5. The node according to claim 1, wherein the database further comprises an identity of the PLMN of the receiving subscriber.

6. The node according to claim 1, wherein the database further comprises an address to the GGSN to which the receiving subscriber belongs to.

7. The node according to claim 1, wherein the database is located in a GGSN.

8. The node according to claim 1, wherein the database is located in a proxy.

9. The node according to claim 1, wherein the database is located in a Home Location Register (HLR).

10. The node according to claim 1, wherein the database is located in a separate node.

11. The node according to claim 1, wherein further comprising a port opening means for opening a firewall.

12. The node according to claim 11, wherein the port opening means comprises a functionality for mapping a private IP address to a public IP address associated with a port number.

13. The node according to claim 12, wherein the functionality for mapping private IP addresses to public IP addresses associated with the port number is located in a proxy.

14. The node according to claim 12, wherein the proxy comprises means for using Network Address Translation services for performing the mapping.

15. The node according to claim 11, wherein further comprising a functionality for initiating a radio connection to the receiving subscriber.

16. The node according to claim 1, wherein the node is connectable to a GRX network.

17. The node according to claim 16, wherein the GRX node is arranged to parse the MSISDN and to use a Flexible Number Register (FNR) to determine the mobile country code (mcc)/mobile network code (mnc) of the network wherein the receiving subscriber is.
